(19) United States
(12) Patent Application Publication
(10) Pub. No.: US 2012/0121113 A1
(43) Pub. Date: May 17, 2012

(54) Directional control of sound in a vehicle

(75) Inventor: Yunhong Li, Santa Clara, CA (US)

(73) Assignee: National Semiconductor Corporation, Santa Clara, CA (US)

(21) Appl. No.: 12/927,464

(22) Filed: Nov. 16, 2010

(51) Int. Cl. H04R 5/02; H04B 1/00

(52) U.S. Cl. 381/302; 381/86

(57) ABSTRACT

A system for directing sound in a vehicle includes a passenger selector, a controller, a pattern generator and a speaker array. The passenger selector is configured to generate a direction signal based on a selection of at least one passenger in the vehicle. The controller is configured to generate a pattern signal based on the direction signal. The pattern generator is configured to receive unpatterned audio data and to generate patterned audio data based on the pattern signal. The speaker array is configured to receive the patterned audio data and to generate a directed sound field based on the patterned audio data such that the directed sound field is directed toward the at least one selected passenger.

### CROSS-REFERENCE TO RELATED APPLICATION

This application is related to U.S. patent application Ser. No. 12/874,502 filed on Sep. 2, 2010, which is hereby incorporated by reference.

### TECHNICAL FIELD

This disclosure is generally directed to audio systems. More specifically, this disclosure is directed to the directional control of sound in a vehicle.

### BACKGROUND

Current automobile infotainment and multimedia systems usually include at least a front pair and a rear pair of speakers. The speakers are typically configured in conventional stereo mode, and the output power is generally high so that audio content can be heard by all passengers. If a driver prefers not to listen to the audio content related to the entertainment being enjoyed by other passengers, conventional options include requiring the other passengers to wear headphones or adjusting the fader so that the audio content is generated only by the rear speakers and not by the front speakers.

The headphone solution is problematic because headphones may be cost prohibitive, and other passengers may prefer not to wear headphones while traveling. The fader adjustment solution is also problematic because the driver can still hear the audio content relatively clearly. This solution merely results in a slight decrease in the sound level, which can still be loud enough to be distracting to the driver.

### BRIEF DESCRIPTION OF DRAWINGS

For a more complete understanding of this disclosure and its features, reference is now made to the following description, taken in conjunction with the accompanying drawings, in which:

FIG. 1 illustrates an example audio system capable of directing sound in a vehicle in accordance with one embodiment of this disclosure;

FIGS. 2A-C illustrate examples of particular implementations of the audio system of FIG. 1 in accordance with some embodiments of this disclosure;

FIG. 3 illustrates an example method for directing sound in a vehicle in accordance with one embodiment of this disclosure;

FIG. 4 illustrates an example method for directing sound in a vehicle in accordance with another embodiment of this disclosure; and

FIG. 5 illustrates an example method for directing sound in a vehicle in accordance with yet another embodiment of this disclosure.

### DETAILED DESCRIPTION

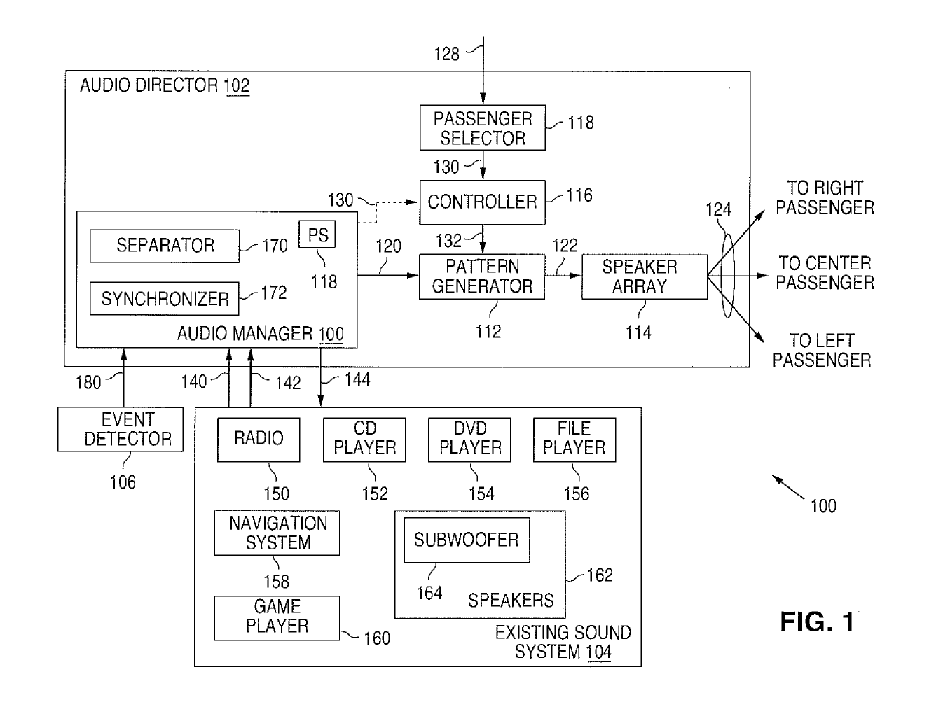

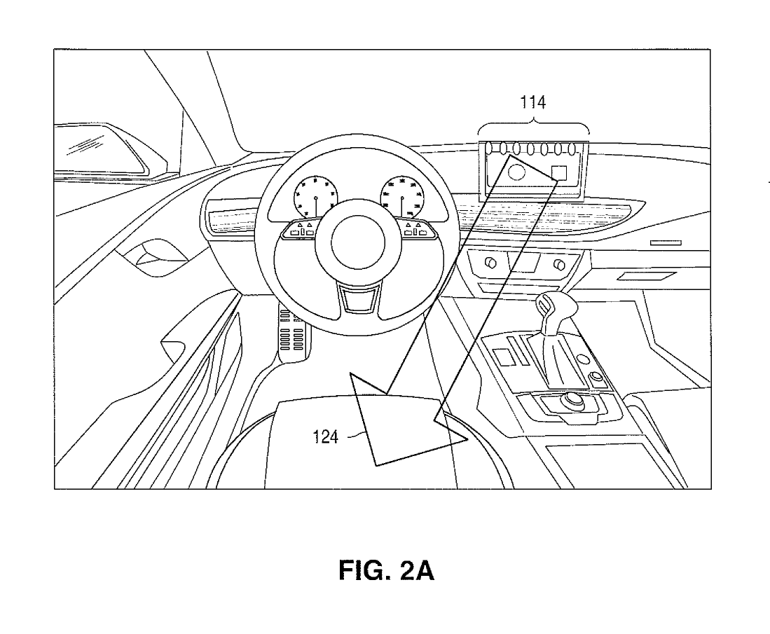

FIGS. 1 through 5, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example audio system 100 capable of directing sound in a vehicle in accordance with one embodiment of this disclosure. The audio system 100 provides for the creation of personalized listening zones inside a vehicle that can enhance the listening experience even with the increasing diversity of automobile infotainment and multimedia applications that are available. For example, the driver may want to concentrate on GPS voice commands, while the backseat passengers may want to watch DVDs without interfering with each other. The audio system 100 allows relatively small speaker arrays inside the vehicle to provide these desirable sound effects.

As described in more detail below and in U.S. patent application Ser. No. 12/874,502, the speaker arrays may be used independently, of existing sound systems to create highly directional sound that results in more personalized listening zones. The speaker arrays may also be implemented as add-on devices to existing sound systems in order to add or enhance audio spatial cues and thus improve the listening experience. Each speaker array includes multiple speakers, each of which has an input that has been processed by audio beamforming techniques. By using audio beamforming, the sound field resulting from each speaker array can be designed to be any of a number of different patterns to suit different applications.

As shown in FIG. 1, the audio system 100 includes an audio director 102 that may be coupled to an existing sound system 104 in a vehicle. For some embodiments, the audio director 102 may also be coupled to an event detector 106 in the vehicle. The audio director 102 includes an audio manager 110, a pattern generator 112, a speaker array 114, a controller 116 and a passenger selector 118.

The audio manager 110 is coupled to the pattern generator 112 and is capable of providing unpatterned audio data 120 to the pattern generator 112. The pattern generator 112 is coupled to the speaker array 114 and is capable of providing distributed beamforming by generating patterned audio data 122 based on the unpatterned audio data 120 and providing that patterned audio data 122 to the speaker array 114. For some embodiments, the pattern generator 112 may include a plurality of filters and may be capable of applying those filters to the unpatterned audio data 120 to generate the patterned audio data 122. Details of example techniques for the distributed beamforming that could be performed by the pattern generator 112 are provided in U.S. patent application Ser. No. 12/874,502. However, note that any other suitable spatial signal processing technique could be used. The speaker array 114 is capable of generating a directed sound field 124 based on the patterned audio data 122.

For the illustrated embodiment, the directed sound field 124 may include a component directed toward a right passenger, a center passenger, a left passenger or any suitable combination of such components. However, it will be understood that the directed sound field 124 may include components directed in any suitable direction based on the location of the speaker array 114 in the vehicle in comparison to possible passenger locations in the vehicle. For example, if a speaker array 114 is located directly behind the driver's seat, the directed sound field 124 may include components directed toward a center passenger (with reference to the speaker array 114), a right passenger and/or a far right passenger. Because no passengers would be seated to the left of the speaker array 114 in this example, there would be no need for this particular speaker array 114 to direct sound toward the left.

For some embodiments, the passenger selector 118 may be coupled to the controller 116. The passenger selector 118 is capable of receiving a passenger selection signal 128 and generating a direction signal 130 for the controller 116 based on the passenger selection signal 128. The controller 116 is coupled to the pattern generator 112 and is capable of generating a pattern signal 132 for the pattern generator 112 based on the direction signal 130. For some embodiments, the passenger selector 118 may be integrated into the audio manager 110, which may then be capable of providing the direction signal 130 to the controller 116.

The existing sound system 104 in the vehicle may include any suitable components. For the illustrated embodiment, the sound system 104 includes a plurality of sources, including an AM/FM/XM radio 150, a CD player 152, a DVD player 154, a file player 156 (such as an APPLE IPOD), a navigation system 158 and a game player 160. Also, each sound source can be mono, stereo or multi-channel. The sound system 104 also includes speakers 162, including one or more subwoofers 164.

The existing sound system 104 may provide sound system audio 140 to the audio manager 110. For example, the sound system audio 140 may include music when the file player 156 is the selected source or voice commands when the navigation system 158 is the selected source. The sound system 104 may also be capable of providing sound system information 142 to the audio manager 110. The sound system information 142 may include information regarding which source of the sound system 104 has been selected, which passenger(s) should be selected and/or any other suitable information that may be useful for the audio manager 110.

For some embodiments, the audio manager 110 may include a separator 170 and a synchronizer 172. For these embodiments, higher frequencies may be patterned and provided in the directed sound field 124, while lower frequencies may be redirected back to the sound system 104 for output from the existing subwoofer(s) 164. The separator 170 is capable of separating the sound system audio 140 into high frequency audio and low frequency audio 144. As used here, “low frequency audio” means audio generally provided to a subwoofer 164, while “high frequency audio” means frequencies higher than the low frequency audio 144.

The audio director 102 is capable of generating the directed sound field 124 for the high frequency audio as described above. The synchronizer 172 is capable of synchronizing the audio output of the high frequency audio through the speaker array 114 with the audio output of the low frequency audio 144 through the subwoofer 164. For example, the synchronizer 172 may delay the high frequency audio and/or the low frequency audio 144 based on the time difference to process audio through the pattern generator 112 and speaker array 114 as compared to through the sound system 104.

For some embodiments, the passenger selection signal 128 may be provided by a passenger in the vehicle making a selection of one or more passengers toward which the directed sound field 124 should be directed and/or a selection of one or more passengers toward which sound reduction should be directed. The directed sound field 124 may thus be shaped to provide sound toward specified passengers and, if desired, sound reduction may be included to minimize sound leakage to other passengers.

For some embodiments, the passenger selection signal 128 may be generated automatically by either the sound system 104 or the audio manager 110 based on which sound source has been selected in the existing sound system 104. For these embodiments, the sound system information 142 may include the passenger selection signal 128 and/or a source identifier capable of identifying which source 150, 152, 154, 156, 158 or 160 has been selected. If the passenger selection signal 128 is not included in the sound system information 142, the audio manager 110 may be capable of identifying the passenger(s) to be selected based on the source identifier.

For example, when the navigation system 158 has been selected, the passenger selection signal 128 may be automatically generated such that the driver is selected as the passenger to which the directed sound field 124 should be directed. For these embodiments, an option may be provided of allowing a passenger to override the automatic selection and provide a different passenger selection signal 128 based on input from the passenger instead of providing the automatic default passenger selection signal 128 for that sound source.

For some embodiments, the audio system 100 may include the (optional) event detector 106. The event detector 106 is capable of detecting an event and notifying one or more passengers in the vehicle of that event. For example, the event detector 106 may be capable of detecting a siren for an emergency vehicle, such as an ambulance or fire truck, or a siren for a police vehicle. The event detector 106 is capable of providing a notification to the passengers in the form of an alarm sound. For some embodiments, the event detector 106 may also be capable of identifying from which direction the event was detected. For example, the event detector 106 may be able to determine that a siren is sounding to the left of the vehicle or behind the vehicle. The event detector 106 may then provide a notification of both the existence of the event and the approximate direction from which the event was detected.

For these embodiments, the event detector 106 is coupled to the audio director 102 and is capable of providing event data 180 to the audio manager 110. Based on the event data 180, the audio director 102 may produce a directed sound field 124 that is directed toward the driver because the driver is the passenger who needs the information so that he or she may react in an appropriate manner, such as pulling over for a police officer or an ambulance, stopping at a green light for a fire engine approaching an intersection, or other suitable action. For embodiments in which the event detector 106 is capable of determining a direction associated with the event, the audio director 102 may also produce the directed sound field 124 such that the audio is directed toward the left or right ear of the driver or the front or back of the driver's head. In this way, the driver has an audio indication of the direction of the event, in addition to the notification of the existence of the event.

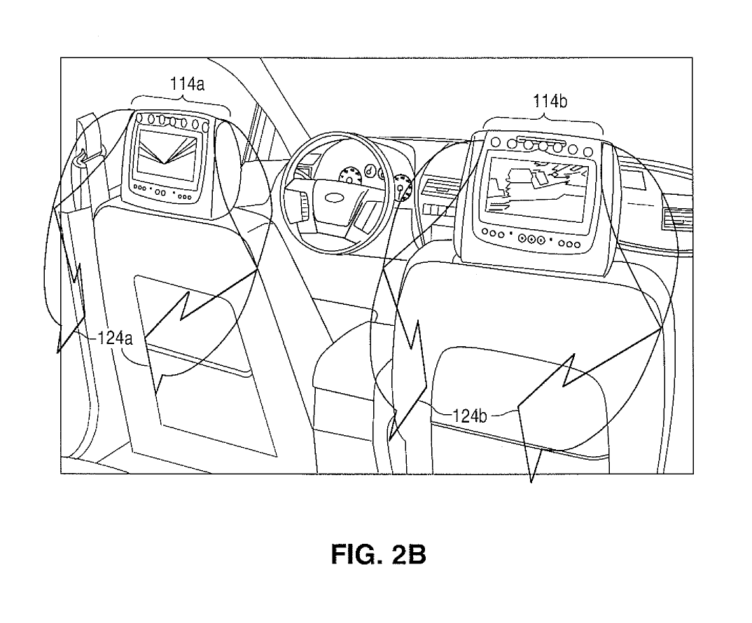

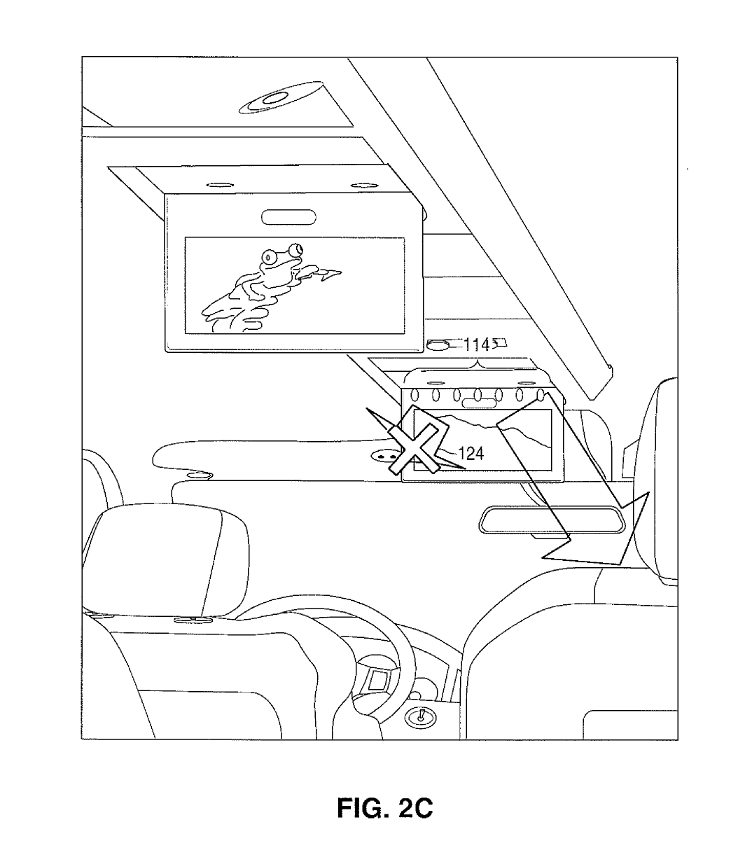

FIGS. 2A-C illustrate examples of particular implementations of the audio system 100 of FIG. 1 in accordance with some embodiments of this disclosure. In these examples, only the speaker array 114 of the audio director 102 is shown. However, it will be understood that the other components of the audio director 102 are coupled to the speaker array 114 in a location that is not visible to the passengers in the vehicle. For the example illustrated in FIG. 2A, the speaker array 114 generates the directed sound field 124 such that the audio is directed toward the driver.

For the example illustrated in FIG. 2B, one speaker array 114a behind the driver's seat generates a directed sound field 124a such that the audio is directed toward the left rear passenger, while another speaker array 114b behind the front passenger's seat generates a directed sound field 124b such that the audio is directed toward the right rear passenger. Thus, for this example, two passengers in the back seat may be able to watch different movies at the same time, or one may watch a movie while the other plays a video game, or any other combination of two different sources may be provided to the passengers.

Alternatively, the same source could be presented to both passengers. Also, because the audio is directed to the back seat passengers, the sound is substantially diminished in the area of the driver and the front passenger, thereby reducing distractions for them caused by the entertainment for the back seat passengers.

For the example illustrated in FIG. 2C, the speaker array 114 generates a directed sound field 124 such that the audio is directed toward the front passenger, while the sound leakage toward the driver is minimized by sound reduction in that direction. Thus, for this example, the front passenger may enjoy an entertainment option without distracting the driver with the accompanying audio.

Thus, using this audio system 100, each passenger in the vehicle may have personalized entertainment options without bothering other passengers in the vehicle. A variety of combinations would also allow some passengers to share one entertainment option, while other passengers may be free of audio distractions or enjoy a different entertainment option.

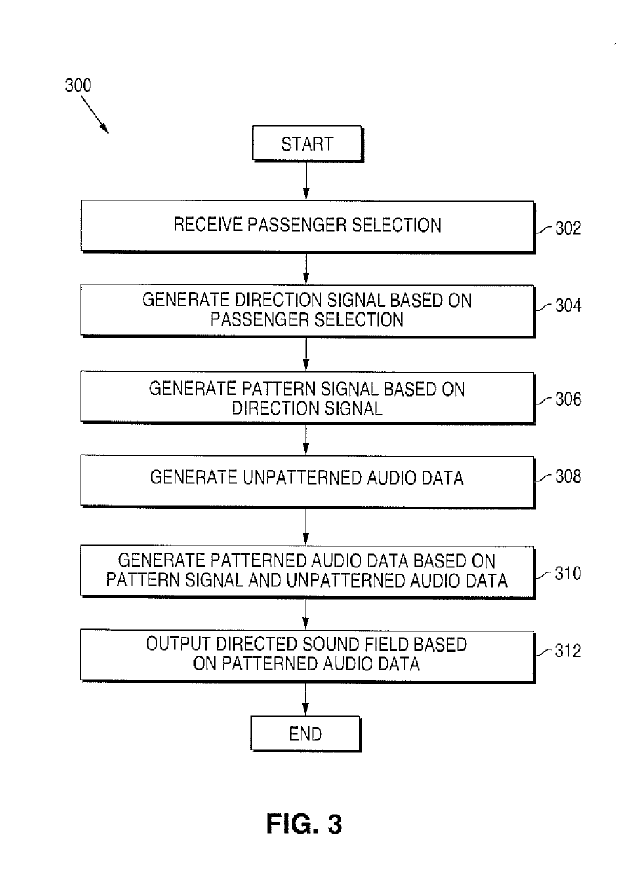

FIG. 3 illustrates an example method 300 for directing sound in a vehicle in accordance with one embodiment of this disclosure. Initially, a passenger selection is received (step 302). For example, a passenger in the vehicle may generate a passenger selection signal 128 by making a selection of one or more passengers to correspond to a particular source of the sound system 104. Alternatively, the audio manager 110 and/or the sound system 104 may automatically make a passenger selection based on the selected source.

The passenger selector 118 generates the direction signal 130 based on the passenger selection (step 304). For example, if the passenger selection corresponds to the front passenger, the direction signal 130 may be generated such that the resulting directed sound field 124 will be directed toward the right passenger for a speaker array 114 that is positioned in the middle of the dashboard.

The controller 116 generates the pattern signal 132 based on the direction signal 130 (step 306). For example, if the direction signal 130 indicates that the directed sound field 124 should be directed toward the right passenger, the controller 116 generates the pattern signal 132 for the pattern generator 112 to accomplish that. As described in more detail in U.S. patent application Ser. No. 12/874,502, the pattern signal 132 may include a plurality of filter coefficients or other suitable information that may be used by the pattern generator 112 in shaping the directed sound field 124.

The audio manager 110 generates unpatterned audio data 120 for the pattern generator 112 (step 308). For example, audio from the CD player 152 may be provided as sound system audio 140 from the sound system 104 to the audio manger 110. The audio manager 110 then provides that audio 140 to the pattern generator 112 as unpatterned audio data 120.

The pattern generator 112 generates patterned audio data 122 based on the pattern signal 132 and the unpatterned audio data 120 (step 310). For example, the pattern generator 112 may apply filters to the unpatterned audio data 120 using filter coefficients provided in the pattern signal 132 in order to generate the patterned audio data 122. As previously discussed, details of the operation of the pattern generator 112 are provided in U.S. patent application Ser. No. 12/874,502.

The speaker array 114 outputs the directed sound field 124 based on the patterned audio data 122 received from the pattern generator 112 (step 312).

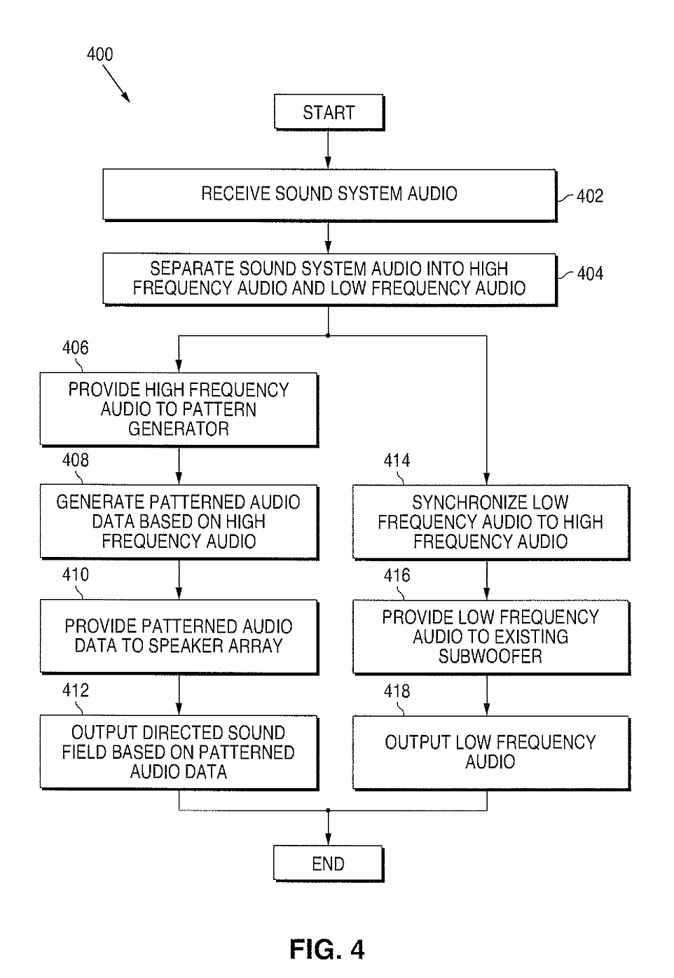

FIG. 4 illustrates an example method 400 for directing sound in a vehicle in accordance with another embodiment of this disclosure. Initially, the audio manager 110 receives sound system audio 140 from the sound system 104 (step 402). The separator 170 separates the sound system audio 140 into high frequency audio and low frequency audio 144 (step 404).

The audio manager 110 provides the high frequency audio as unpatterned audio data 120 to the pattern generator 112 (step 406). The pattern generator 112 generates patterned audio data 122 based on the high frequency audio as described above in connection with FIGS. 1 and 3 (step 408) and provides the patterned audio data 122 to the speaker array 114 (step 410). The speaker array 114 outputs a directed sound field 124 based on the patterned audio data 122 (step 412).

While the audio manager 110 provides the high frequency audio to the pattern generator 112 (at step 406), the synchronizer 172 synchronizes the low frequency audio 144 to the high frequency audio as described below (step 414). The audio manager 110 provides the synchronized low frequency audio 144 to the existing subwoofer 164 of the sound system 104 (step 416). The subwoofer 164 outputs the low frequency audio 144 (step 418).

Returning to step 414, the synchronizer 172 synchronizes the high and low frequency audio such that the directed sound field 124 is output by the speaker array 114 (at step 412) at substantially the same time as the low frequency audio 144 is output by the subwoofer 164 (at step 418). In this way, the audio system 100 may make use of the existing subwoofer 164 and, thus, the speaker array 114 need not include a subwoofer.

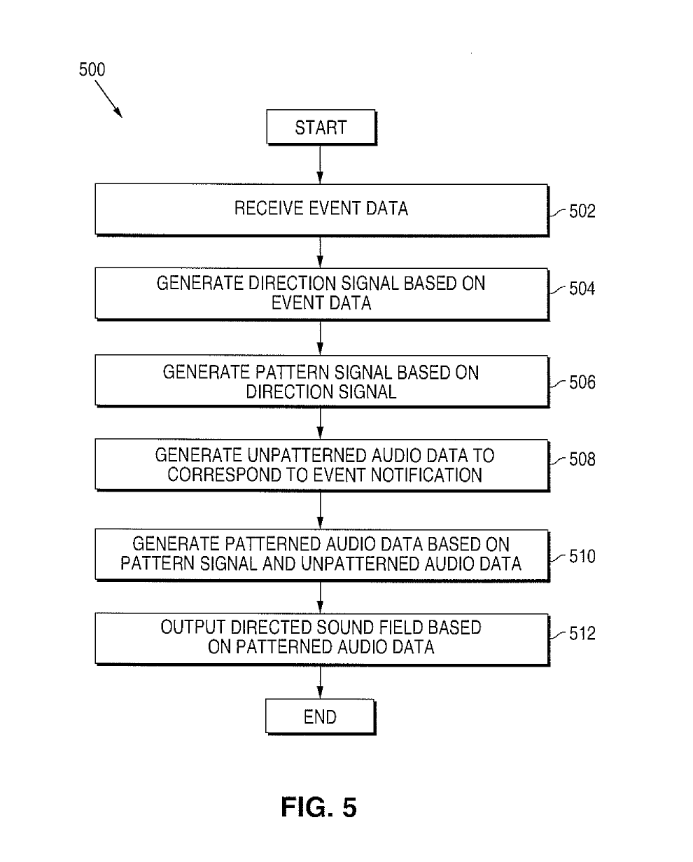

FIG. 5 illustrates an example method 500 for directing sound in a vehicle in accordance with yet another embodiment of this disclosure. Initially, the audio manager 110 receives event data 180 from the event detector 106 (step 502). For example, the event data 180 may include the detection of an event for which notification is desired. The event data 180 may also include location information regarding the general direction of the event as compared to the vehicle.

The audio manager 110 generates a direction signal 130 for the controller 116 based on the event data 180 (step 504). The direction signal 130 causes the controller 116 to direct the directed sound field 124 toward the driver. For embodiments in which the event data 180 includes location information, the direction signal 130 may also cause the controller 116 to direct the directed sound field 124 toward a particular side of the driver, such as the left, right, front or back side of the driver.

The controller 116 generates the pattern signal 132 based on the direction signal 130 (step 506). For example, if the direction signal 130 indicates that the directed sound field 124 should be directed toward the right side of the driver's head, the controller 116 generates the pattern signal 132 for the pattern generator 112 to accomplish that. As described in more detail in U.S. patent application Ser. No. 12/874,502, the pattern signal 132 may include a plurality of filter coefficients or other suitable information that may be used by the pattern generator 112 in shaping the directed sound field 124.

The audio manager 110 generates unpatterned audio data 120 for the pattern generator 112 to correspond to the event notification (step 508). For example, the event detector 106 may provide an alarm sound or other suitable audible indicator of the event as part of the event data 180. The audio manager 110 then provides this audio data to the pattern generator 112 as unpatterned audio data 120.

The pattern generator 112 generates patterned audio data 122 based on the pattern signal 132 and the unpatterned audio data 120 (step 510). For example, the pattern generator 112 may apply filters to the unpatterned audio data 120 using filter coefficients provided in the pattern signal 132 in order to generate the patterned audio data 122. As previously discussed, details of the operation of the pattern generator 112 are provided in U.S. patent application Ser. No. 12/874,502.

The speaker array 114 outputs the directed sound field 124 based on the patterned audio data 122 received from the pattern generator 112 (step 512).

Thus, using the audio system 100 described above, the overall sound energy may be reduced because the sound energy is more efficiently delivered to fewer than all the passengers. By focusing the sound, audio content may be perceived more clearly over ambient noise, which greatly improves content intelligibility. In addition, using the speaker array 114, the sound stage perceived by the listener is greatly widened as compared to what may be perceived from conventional stereo speakers installed in the same location.

While FIGS. 1 through 5 have illustrated various features of different types of audio systems and methods, any number of changes may be made to these drawings. For example, the components or steps shown in the figures could be combined, omitted, or further subdivided and additional components could be added according to particular needs. In addition, features shown in one or more figures above may be used in other figures above. Furthermore, at least some of the components of the audio director 102 may be duplicated or otherwise configured to provide patterned audio data 122 based on audio from the same or different sources of the sound system 104 to multiple speaker arrays 114, such as shown in FIG. 2B, in order to provide different entertainment options to different passengers in the vehicle.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases that have been used within this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The term “each” means every one of at least a subset of the identified items. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like.

While this disclosure has described certain embodiments and generally associated methods, alterations and permutations of these embodiments and methods will be apparent to those skilled in the art. Accordingly, the above description of example embodiments does not define or constrain this invention. Other changes, substitutions, and alterations are also possible without departing from the spirit and scope of this invention as defined by the following claims.

What is claimed is:

1. A system for directing sound in a vehicle, comprising:
a passenger selector configured to generate a direction signal based on a selection of at least one passenger in the vehicle;
a controller configured to generate a pattern signal based on the direction signal;
a pattern generator configured to receive unpatterned audio data and to generate patterned audio data based on the pattern signal; and
a speaker array configured to receive the patterned audio data and to generate a directed sound field based on the patterned audio data such that the directed sound field is directed toward the at least one selected passenger.

2. The system of claim 1, wherein the pattern generator comprises a plurality of filters configured to apply filter coefficients to the unpatterned audio data to generate the patterned audio data.

3. The system of claim 2, wherein:
the controller is configured to generate the filter coefficients based on the direction signal; and
the pattern signal comprises the filter coefficients.

4. The system of claim 1, wherein the directed sound field comprises sound reduction directed toward at least one unselected passenger.

5. The system of claim 1, further comprising:
an audio manager configured to receive sound system audio from a sound system in the vehicle and to generate the unpatterned audio data from the sound system audio.

6. The system of claim 5, wherein the audio manager comprises:
a separator configured to separate the sound system audio into high frequency audio and low frequency audio; and
a synchronizer configured to synchronize the high frequency audio with the low frequency audio.

7. The system of claim 6, wherein the audio manager is further configured to provide the high frequency audio as the unpatterned audio data and to redirect the low frequency audio back to the sound system.

8. The system of claim 5, wherein:
the audio manager comprises the passenger selector; and
the audio manager is coupled to the controller.

9. The system of claim 1, wherein:
the speaker array comprises a first speaker array;
the patterned audio data comprises first patterned audio data;
the directed sound field comprises a first directed sound field;
the at least one selected passenger comprises at least one first selected passenger; and
the system further comprises a second speaker array configured to generate a second directed sound field directed toward at least one second selected passenger based on second patterned audio data.

10. A method for directing sound in a vehicle, comprising:
receiving a selection of at least one passenger;
generating a direction signal based on the selection, wherein the direction signal indicates in which direction the at least one selected passenger is seated compared to a speaker array;
generating a pattern signal based on the direction signal;
generating patterned audio data based on unpatterned audio data and the pattern signal; and
outputting from the speaker array a directed sound field based on the patterned audio data, wherein the directed sound field is directed toward the at least one selected passenger.

11. The method of claim 10, wherein generating the patterned audio data comprises applying a plurality of filters to the unpatterned audio data.

12. The method of claim 11, wherein generating the pattern signal comprises providing filter coefficients for each of the filters.

13. The method of claim 10, wherein the directed sound field comprises sound reduction directed toward at least one unselected passenger.

14. The method of claim 10, further comprising:
receiving sound system audio from a sound system;
separating the sound system audio into high frequency audio and low frequency audio; and
synchronizing the high frequency audio with the low frequency audio.

15. The method of claim 14, further comprising:
providing the high frequency audio as the unpatterned audio data; and
redirecting the low frequency audio back to the sound system.

16. A method for directing sound in a vehicle, comprising:
receiving event data;
generating a direction signal based on the event data, wherein the direction signal indicates in which direction a driver of the vehicle is seated compared to a speaker array;
generating a pattern signal based on the direction signal;
generating patterned audio data based on the event data and the pattern signal; and
outputting from the speaker array a directed sound field based on the patterned audio data, wherein the directed sound field is directed toward the driver.

17. The method of claim 16, wherein the event data comprises a notification of a siren.

18. The method of claim 17, wherein the event data further comprises location information.

19. The method of claim 18, wherein the location information comprises a direction of the siren compared to the vehicle.

20. The method of claim 19, wherein the directed sound field is further directed toward one of a left, a right, a front and a back of the driver based on the direction of the siren.
